(19) United States
(12) Patent Application Publication
(10) Pub. No.: US 2022/0415318 A1
(43) Pub. Date: Dec. 29, 2022

(54) VOICE ASSISTANT ACTIVATION SYSTEM WITH CONTEXT DETERMINATION BASED ON MULTIMODAL DATA

(71) Applicant: Cerence Operating Company, Burlington, MA (US)

(72) Inventors: Stefan Werner HAMERICH, Ulm (DE); Holger QUAST, Merelbeke (DE); Mohammad Mehdi MONIRI, Düsseldorf (DE); Niels DOES, Ulm (DE)

(73) Assignee: Cerence Operating Company, Burlington, MA (US)

(21) Appl. No.: 17/357,464

(22) Filed: Jun. 24, 2021

(51) Int. Cl. G10L 15/22; G10L 15/02; G06K 9/00

(52) U.S. Cl. CPC G10L 15/22; G10L 15/02; G06K 9/00845; G06K 9/00597; G06K 9/00335

(57) ABSTRACT

A vehicle system for classifying spoken utterance within a vehicle cabin as one of system-directed and non-system directed may include at least one microphone to detect at least one acoustic utterance from at least one occupant of the vehicle, at least one camera to detect occupant data indicative of occupant behavior within the vehicle corresponding to the acoustic utterance, and a processor programmed to receive the acoustic utterance, receive the occupant data, determine whether the occupant data is indicative of a vehicle feature, classify the acoustic utterance as a system-directed utterance in response to the occupant data being indicative of a vehicle feature, and process the acoustic utterance.

### FIELD OF THE INVENTION

Described herein are voice assistant activation systems for systems having contextual determination based on multimodal data.

### BACKGROUND OF THE INVENTION

Many systems and applications are presently speech enabled, allowing users to interact with the system via speech (e.g., enabling users to speak commands to the system). Engaging speech-enabled systems often requires users to signal to the system that the user intends to interact with the system via speech. For example, some speech recognition systems may be configured to begin recognizing speech once a manual trigger, such as a button push (e.g., a button of a physical device and/or a button within a speech recognition software application), launch of an application or other manual interaction with the system, is provided to alert the system that speech following the trigger is directed to the system. However, manual triggers complicate the interaction with the speech-enabled system and, in some cases, may be prohibitive (e.g., when the user's hands are otherwise occupied, such as when operating a vehicle, or when the user is too remote from the system to manually engage with the system or an interface thereof).

Some speech-enabled systems allow for voice triggers to be spoken to begin engaging with the system, thus eliminating at least some (if not all) manual actions and facilitating generally hands-free access to the speech-enabled system. Use of a voice trigger may have several benefits, including greater accuracy by deliberately not recognizing speech not directed to the system, a reduced processing cost since only speech intended to be recognized is processed, less intrusive to users by only responding when a user wishes to interact with the system, and/or greater privacy since the system may only transmit or otherwise process speech that was uttered with the intention of the speech being directed to the system.

A voice trigger may comprise a designated word or phrase that is spoken by the user to indicate to the system that the user intends to interact with the system (e.g., to issue one or more commands to the system). Such voice triggers are also referred to herein as a “wake-up word” or “WuW” and refer to both single word triggers and multiple word triggers. Typically, once the wake-up word has been detected, the system begins recognizing subsequent speech spoken by the user. In most cases, unless and until the system detects the wake-up word, the system will assume that the acoustic input received from the environment is not directed to or intended for the system and will not process the acoustic input further. However, requiring WuW may cause unnecessary effort by the users and increase frustration.

### SUMMARY OF THE INVENTION

A vehicle system for classifying spoken utterance within a vehicle cabin as one of system-directed and non-system directed may include at least one microphone to detect at least one acoustic utterance from at least one occupant of the vehicle, at least one camera to detect occupant data indicative of occupant behavior within the vehicle corresponding to the acoustic utterance, and a processor programmed to receive the acoustic utterance, receive the occupant data, determine whether the occupant data is indicative of a vehicle feature, classify the acoustic utterance as a system-directed utterance in response to the occupant data being indicative of a vehicle feature, and process the acoustic utterance.

A method for classifying spoken utterance within a vehicle cabin as one of system-directed and non-system directed, the method may include receiving an acoustic utterance from a vehicle occupant from at least one microphone, receiving occupant data indicative of occupant behavior from at least one camera, determining whether the occupant data is indicative of occupant attention directed to a vehicle feature, and classifying the acoustic utterance as a system-directed utterance in response to the occupant data being indicative of the occupant attention to the vehicle feature.

An audio system for classifying spoken utterance as one of system-directed and non-system directed, the system may include at least one microphone configured to detect at least one acoustic utterance from at least one user; at least one camera configured to detect data indicative of user behavior associated with the acoustic utterance; a memory configured to maintain a database of user behaviors, and a processor programmed to receive the acoustic utterance, receive the data indicative of the user behavior, determine whether the user behavior is associated with the acoustic utterance, classify the acoustic utterance as a system-directed utterance in response to the data indicative of the user behavior being associated with the acoustic utterance, and process the acoustic utterance.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompany drawings in which:

FIG. 1 illustrates a block diagram for a voice assistant system in an automotive application having a multimodal input processing system in accordance with one embodiment;

FIG. 2 illustrates an example vehicle interior for facilitating the automotive voice assistant system of FIG. 1;

FIG. 3 illustrates an example block diagram of at least a portion of the system of FIG. 1; and

FIG. 4 illustrates an example flow chart for a process for the automotive voice assistant system of FIG. 1.

### DETAILED DESCRIPTION OF THE PREFERRED EMBODIMENT(S)

Voice command systems may analyze spoken commands from users to perform certain functions. For example, in a vehicle, an occupant may state “turn on the music.” This may be understood to be a command to turn on the radio. Such commands are known as system-directed (SD) commands. Other times human speech may be human-to-human conversation and not intended to be a command. These utterances may be known as non-system directed (NSD) utterances. For example, a vehicle occupant may state “there was a concert last night and I hear the music was nice.”

Disclosed herein is an auxiliary mechanism for classifying whether an utterance is a system-directed utterance or a non-system directed utterance based on factors such as a user's tone of voice in addition to other factors. For example, the system may include processor for implementing a statistical classifier with a model that has learned based on example data whether users usually change their gaze and/or gestures when speaking a command vs. speaking non-system directed utterances. In an automotive example, a speaker may usually look at the display in a vehicle's center console when speaking a command related to commands indicated or controlled by the display. The system may use speaker data indicating gaze, head position, or gestures, as non-speech context cues to aid in determining when the speaker is speaking system directed utterance.

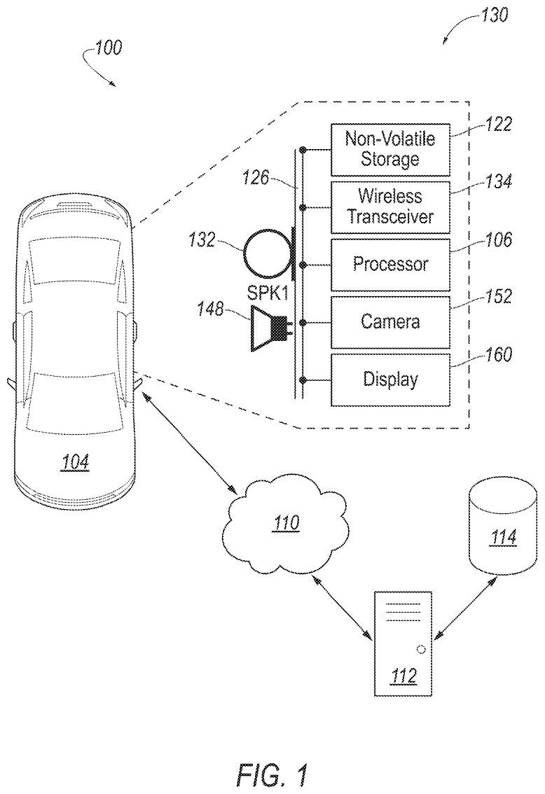

FIG. 1 illustrates a block diagram for an automotive voice assistant system 100 having a multimodal input processing system in accordance with one embodiment. The automotive voice assistant system 100 may be designed for a vehicle 104 configured to transport passengers. The vehicle 104 may include various types of passenger vehicles, such as crossover utility vehicle (CUV), sport utility vehicle (SUV), truck, recreational vehicle (RV), boat, plane or other mobile machine for transporting people or goods. Further, the vehicle 104 may be autonomous, partially autonomous, self-driving, driverless, or driver-assisted vehicles. The vehicle 104 may be an electric vehicle (EV), such as a battery electric vehicle (BEV), plug-in hybrid electric vehicle (PHEV), hybrid electric vehicle (HEVs), etc.

The vehicle 104 may be configured to include various types of components, processors, and memory, and may communicate with a communication network 110. The communication network 110 may be referred to as a “cloud” and may involve data transfer via wide area and/or local area networks, such as the Internet, Global Positioning System (GPS), cellular networks, Wi-Fi, Bluetooth, etc. The communication network 110 may provide for communication between the vehicle 104 and an external or remote server 112 and/or database 114, as well as other external applications, systems, vehicles, etc. This communication network 110 may provide navigation, music or other audio, program content, marketing content, internet access, speech recognition, cognitive computing, artificial intelligence, to the vehicle 104.

The remote server 112 and the database 114 may include one or more computer hardware processors coupled to one or more computer storage devices for performing steps of one or more methods as described herein and may enable the vehicle 104 to communicate and exchange information and data with systems and subsystems external to the vehicle 104 and local to or onboard the vehicle 104. The vehicle 104 may include one or more processors 106 configured to perform certain instructions, commands and other routines as described herein. Internal vehicle networks 126 may also be included, such as a vehicle controller area network (CAN), an Ethernet network, and a media oriented system transfer (MOST), etc. The internal vehicle networks 126 may allow the processor 106 to communicate with other vehicle 104 systems, such as a vehicle modem, a GPS module and/or Global System for Mobile Communication (GSM) module configured to provide current vehicle location and heading information, and various vehicle electronic control units (ECUs) configured to corporate with the processor 106.

The processor 106 may execute instructions for certain vehicle applications, including navigation, infotainment, climate control, etc. Instructions for the respective vehicle systems may be maintained in a non-volatile manner using a variety of types of computer-readable storage medium 122. The computer-readable storage medium 122 (also referred to herein as memory 122, or storage) includes any non-transitory medium (e.g., a tangible medium) that participates in providing instructions or other data that may be read by the processor 106. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/structured query language (SQL).

The processor 106 may also be part of a multimodal processing system 130. The multimodal processing system 130 may include various vehicle components, such as the processor 106, memories, sensors, input devices, displays, etc. The multimodal processing system 130 may include one or more input and output devices for exchanging data processed by the multimodal processing system 130 with other elements shown in FIG. 1. Certain examples of these processes may include navigation system outputs (e.g., time sensitive directions for a driver), incoming text messages converted to output speech, vehicle status outputs, and the like, e.g., output from a local or onboard storage medium or system. In some embodiments, the multimodal processing system 130 provides input/output control functions with respect to one or more electronic devices, such as a heads-yup-display (HUD), vehicle display, and/or mobile device of the driver or passenger, sensors, cameras, etc.

The vehicle 104 may include a wireless transceiver 134, such as a BLUETOOTH module, a ZIGBEE transceiver, a Wi-Fi transceiver, an IrDA transceiver, a radio frequency identification (RFID) transceiver, etc.) configured to communicate with compatible wireless transceivers of various user devices, as well as with the communication network 110.

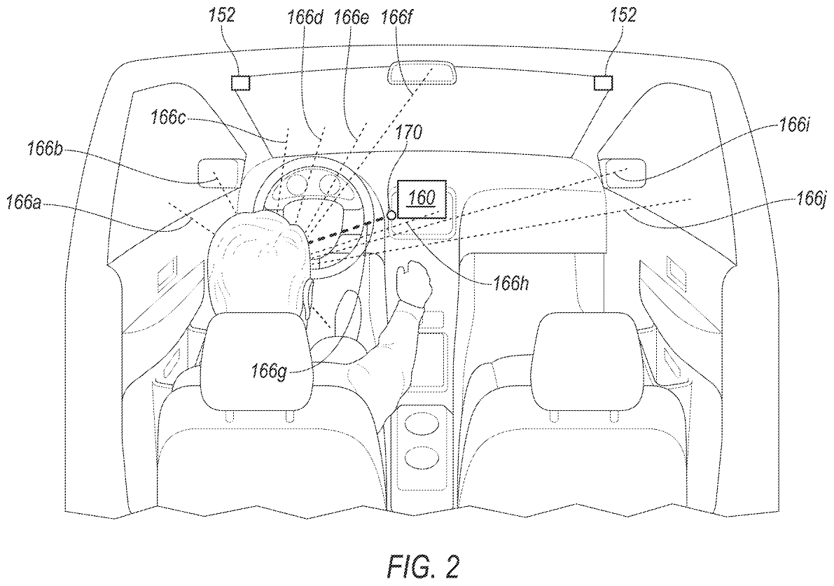

The vehicle 104 may include various sensors and input devices as part of the multimodal processing system 130. For example, the vehicle 104 may include at least one microphone 132. The microphone 132 may be configured receive audio signals from within the vehicle cabin, such as acoustic utterances including spoken words, phrases, or commands from vehicle occupants. The microphone 132 may include an audio input configured to provide audio signal processing features, including amplification, conversions, data processing, etc., to the processor 106. As explained below with respect to FIG. 2, the vehicle 104 may include at least one microphone 132 arranged throughout the vehicle 104. While the microphone 132 is described herein as being used for purposes of the multimodal processing system 130, the microphone 132 may be used for other vehicle features such as active noise cancelation, hands-free interfaces, etc. The microphone 132 may facilitate speech recognition from audio received via the microphone 132 according to grammar associated with available commands, and voice prompt generation. The microphone 132 may include a plurality of microphones 132 arranged throughout the vehicle cabin.

The vehicle 104 may include an audio system having audio playback functionality through vehicle speakers 148 or headphones. The audio playback may include audio from sources such as a vehicle radio, including satellite radio, decoded amplitude modulated (AM) or frequency modulated (FM) radio signals, and audio signals from compact disc (CD) or digital versatile disk (DVD) audio playback, streamed audio from a mobile device, commands from a navigation system, etc.

As explained, the vehicle 104 may include various displays 160 and user interfaces, including HUDs, center console displays, steering wheel buttons, etc. Touch screens may be configured to receive user inputs. Visual displays may be configured to provide visual outputs to vehicle occupants.

The vehicle 104 may include at least one occupant detector device 152 (also referred to herein as camera 152). The occupant detector device 152 may be a position sensor and/or camera configured to detect the direction of the user's gaze, occupant gestures, etc. The occupant detector device 152 may monitor the driver head position, as well as detect any other movement by the occupant, such as a motion with the user's arms or hands, etc. In the example of a camera, the camera may provide imaging data taken of the vehicle occupants to indicate certain movements made by a specific occupant. The camera may be a camera capable of taking still images, as well as video and detecting user head, eye, and body movement. The camera may include multiple cameras and the imaging data may be used for qualitative analysis. For example, the imaging data may be used to determine if the user is looking at a certain location or vehicle display. Additionally or alternatively, the imaging data may also supplement timing information as it relates to the driver motion.

While not specifically illustrated herein, the vehicle 104 may include numerous other systems such as GPS systems, human-machine interface (HMI) controls, video systems, etc. The multimodal processing system 130 may use inputs from various vehicle systems, including the speaker 148 and the occupant detector device 152, to detect, receive, and analyze occupant behavior. This behavior may be in the form of receiving audio commands, occupant gestures, etc. While most systems analyze one form of occupant behavior, such as speech alone, to respond to occupant commands, the multimodal processing system 130 may use inputs from more than one vehicle system or sensor to take a collaborative and inclusive approach to analyzing user commands.

For example, the multimodal processing system 130 may determine whether an utterance by an occupant is system-directed (SD) or non-system directed (NSD). System-directed utterances may be made by an occupant with the intent to affect an output within the vehicle 104 such as a spoken command of “turn on the music.” A non-system directed utterance may be one spoken during conversation to another occupant, while on the phone, or speaking to a person outside of the vehicle. These NSDs are not intended to affect a vehicle output or system. The NSDs may be human-to-human conversations.

In one example, an utterance may be classified as system-directed or non-system directed based on a “tone” of the utterance. When a user's tone of voice is more command-like, the utterance may be classified as system-directed, as opposed to a casual conversational tone, in which the utterance may be classified as non-system directed. Additionally, however, the multimodal processing system 130 may include a statistical classifier with a model that has machine learning capabilities that analyzes both the utterance, as well as other data apart from the utterance. This data may be the sensor data acquired from the occupant detector device 152 that analyzes non-verbal data, such as gaze, position, and gestures, of an occupant. Such non-speech context data may aid in determining what utterances are system-directed and what utterances are non-system directed.

While an automotive system is discussed in detail here, other applications may be appreciated. For example, similar functionally may also be applied to other, non-automotive cases, e.g. for augmented reality or virtual reality cases with smart glasses, phones, eye trackers in living environment, etc. While the term “occupant” is used throughout, this term may be interchangeable with others such as speaker, user, etc.

FIG. 2 illustrates an example vehicle interior (vehicle cabin view) of the automotive voice assistant system 100 of FIG. 1. As explained with respect to FIG. 1, the vehicle 104 may include various components or objects, such as sensors, displays, etc. In one example, the vehicle 104 may include a center console display 160 configured to provide visual output to vehicle occupants. The display 160 may also be configured to receive user inputs via a touch screen, knobs, buttons, etc. The display 160 may control various vehicle systems such as the infotainment systems, climate controls, etc. Often times, when issuing an audible command, an occupant may look at the display 160 out of habit, as the command being given may also be instructed via user interaction with the display 160. For example, the user may adjust the audio volume of the radio or turning a knob on the display 160. The user may also audibly command the volume to adjust by uttering “volume up,” or the like.

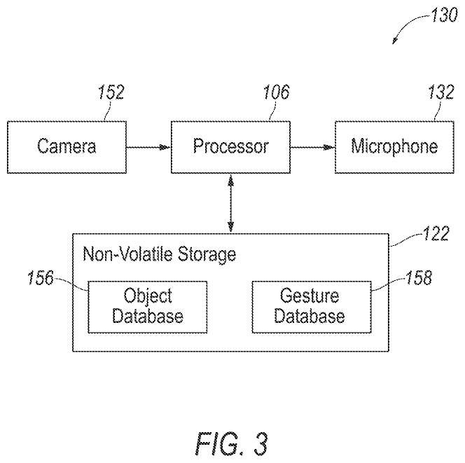

As explained, occupant detector devices 152 may be arranged throughout the vehicle to detect occupant behavior in the form of gestures, position and gaze detection. These devices, or cameras, may communication with the processor 106 (shown in FIGS. 1 and 3) and the multimodal processing system 130 may classify such non-speech data. In the example of FIG. 2, a plurality of gaze directions 166a-j are illustrated for example purposes only. More or fewer gaze directions 166 may be realized. These gaze directions 166a-j include various locations throughout the vehicle cabin that the occupant may gaze. While only one occupant is illustrated in FIG. 2, more than one occupant may be within the vehicle cabin, and the gaze directions, or more generally the occupant behavior, of each occupant may be monitored.

For example, the multimodal processing system 130 may receive occupant data from the camera 152 that indicates that the vehicle driver is looking out of the driver side window (e.g., gaze direction 166a) during an associated utterance. This may indicate that the possibility that the driver is speaking to someone outside of the vehicle, or that the driver is discussing or referring to something external to the vehicle, such as a landmark, accident, the weather, or any other object or occurrence visible to the driver out of the window. The multimodal processing system 130 may determine, in combination with the analyzed speech utterance, that the received utterance is not system-directed, but instead a non-system directed utterance, as it is more probable that the driver is having a conversation with someone either outside the vehicle, or within the vehicle about something outside of the vehicle.

In another example, the camera 152 may detect that an occupant is gazing at the volume knob 170 on or near the display 160 during an utterance by the occupant. This gaze 166g may be detected by cameras 152. While gazing at the volume knob 170, the occupant may utter the phrase “what is this?” Since the occupant is looking at the knob 170 while asking this example question, the multimodal processing system 130 may determine that the utterance is a system-directed utterance. The multimodal processing system 130 may instruct an appropriate response to be given to the occupant, such an audible explanation of the function of the knob 170 via the speakers 148.

FIG. 3 illustrates an example block diagram of a portion of the multimodal processing system 130. In this example block diagram, the processor 106 may be configured to communicate with the microphones 132, occupant detector devices 152, and memory 122. The memory 122 may be configured to maintain an object database 156. The object database 156 may maintain a database of known objects such as vehicle features, controls or components. For example, the database may include a list of objects, including control-type objects that impose an effect on a vehicle system, such as a volume knob, climate control knob, radio button, display (e.g., display 160), windshield wiper controls, window button, etc. These may be considered vehicle features or vehicle functions. The list of objects may also include vehicle objects that do not affect a vehicle system and relate to an area of the vehicle, such as respective windows, sunroof, center console, glove compartment, etc.

Each control-type object may have at least one action or control feature/function associated therewith. For example, a volume knob may be associated with adjusting the speaker volume. The radio button may be associated with adjusting the radio tuning. The display 160 may have more than one action associated therewith, as the display may control infotainment, navigation, climate, etc. The vehicle objects may not have an action associated therewith, but may indicate or imply an area or location within the vehicle. For example, the driver side window may be arranged on a left side of a vehicle.

The memory 122 may also maintain a gesture database 158. The gesture database 158 may maintain a list of defined or recognized gestures, such as an arm wave, waiving of the hand, shaking of the head, etc. Each recognized gesture may include at least one associated vehicle function or vehicle feature. For example, the shaking of the head may infer a response to another utterance spoken by another occupant or speaker. A waiving of the hand at or near the display 160 may indicate a desire to adjust one of the available options on the display, such as to increase or decrease the heat, volume, skip a song, change the radio station, etc. A waiving of an arm or pointing of a finger may indicate that the user is referring to something external to the vehicle 104.

The processor 106 may receive occupant data or speaker data from the cameras 152, such as gaze direction, a gesture, head position, etc. The processor 106 may also receive an utterance from the microphone 132 and correspond the utterance to the occupant data received at or around the same time as the utterance. The processor 106 may determine whether the occupant data is indicative of a certain gaze direction (e.g., the gaze directions 166 as illustrated in FIG. 2), gesture or head position. In one example, if the driver is driving, his or her head gaze may be straight forward. In another example, the passenger may be talking to the driver, and his or her head may be facing the driver. An occupant may be pointing to something outside of the vehicle, in which the occupant data may indicate this gesture. If the processor 106 determines that the occupant data is indicative of a certain recognized gaze detection, gesture or head position, the processor 106 may use this additional data to further classify the associated utterance.

For example, if the occupant data indicates that the occupant's gaze is directed towards the occupant's window, then the object identified is the window. If the utterance associated with the gaze direction is “it's too cold,” then the processor 106 may determine that the utterance is in reference to something external to the vehicle (e.g., and ice skating rink, ski slope, person exercising, etc.) and therefore is non system-directed. However, if the occupant data indicates that the occupant's gaze is directed towards the climate control knob, then the object identified is the climate control knob. If the utterance associated with the gaze direction is “it's too cold,” then the processor 106 may determine that the utterance is in reference to climate control and therefore is system-directed.

In another example, the utterance may be, for example, “what is this?”. If the occupant data indicates that the occupant is looking at the volume control knob, then the processor 106 may determine that there is a high probability that the occupant is inquiring about what the knob does and is therefore a system-directed utterance. However, in another example, for the same utterance, if the occupant's gaze is determined to be directed out of a window, then the processor 106 may determine that the occupant is inquiring about something external to the vehicle 104 and therefore the utterance is non system-directed. This may be especially important for systems that implement actively listen and provide for voice command features without requiring wake up word activation.

In another example, the user may ask “what is this?” while looking outside the vehicle. The camera 152 may track the occupant's or speaker's gaze. The processor 106 may identify a point of interest (POI) based on the speaker's gaze. This may be achieved by cross referencing the gaze data with certain map data to identify the likely gaze direction. The processor 106 may then instruct the speaker 148 to respond to the speaker's question and indicate “you are passing Ingrid's Delicatessen, a local food store selling baked goods and server German & American fare . . . ” Thus, In some examples of the speaker gazing outside the vehicle 104, the utterance could still be considered system-directed.

Thus, by using cues from occupant behavior, the multimodal processing system 130 may more accurately detect system-directed utterances and respond accordingly. The non-speech data, such as the speaker/occupant data, may be used as a statistical classifier to aid in determining whether the speech is system-directed or not. The correlation between the spoken utterance and the speaker's behavior may be used to weigh the spoken utterance to be considered system-directed. By more accurately classifying utterances, false activation of system responses, or failure to recognize system-directed speech, may decrease and user satisfaction of the automotive voice assistant system 100 will increase.

In addition to analyzes occupant data with respect to spoken utterance, the multimodal processing system 130 may also analyze behavior and utterance in totality among more than one occupant or speaker. For example, if two occupants are sitting next to one another, and each have a detected gaze toward the other occupant, the multimodal processing system 130 may determine that there is a high likelihood that the occupants are having a conversation. Similarly, if the occupant data indicates that both occupants are looking out the same window while one of the occupants says, “it's too cold,” the likelihood that the occupants are discussing something occurring external to the vehicle is higher than if only one of the occupants were determined to be looking out of the window. Such “dual” data may further aid in classifying an utterance for more statistical likelihoods to increase the accuracy of determining whether an utterance is system-directed.

Similarly, if a speaker turns to another person and speaks a request like “turn on the music,” even though this is a command the voice assistant can handle and could therefore be classified system-directed, the fact that the speaker is looking at another human in the car may let the processor running the statistical classifier decide that this is a human-directed request and therefore a non-system directed utterance.

Furthermore, the multimodal processing system 130 may continually be learning based on user responses to the system responses. This includes maintaining user responses to certain classifications. The multimodal processing system 130 classify an utterance as non-system directed, and thus does not process or respond to the utterance. However, if the occupant actually intended the utterance to be a command and thus system-directed, the occupant may repeat the utterance. The multimodal processing system 130 may recognize the repeat, as well as the user's tone in speaking the second occurrence of the utterance. The multimodal processing system 130 may recognize that the first occurrence should have been classified as system-directed, and the memory 122 and associated databases may be updated to include characteristics such as the occupant behavior at the time of the first occurrence of the utterance. By classifying this type of behavior as typically accompanying a system-directed utterance, the multimodal processing system 130 may apply this behavior is future determinations, thus created an evolving and learned multimodal processing system 130 to increase accuracy.

While the multimodal processing system 130 is described as using processor 106 and memory 122, various other processors and mediums may be used to carry out the processes and methods herein, including, for example, the remote server 112 and remote database 114. For example, the database 114 may maintain the object database 154 and the gesture database 158 and the processor 106 may communicate via the communication network 110 with the database 114. The database 114 may facilitate vehicle-to-vehicle updates of the object database 154 and the gesture database 158 to include learned response and statistical classifiers in order to more optimize the multimodal processing system 130. Further, while the system herein is discussed as being applied in a vehicle, the system may further be applied to other scenarios such as within a room or building, etc.

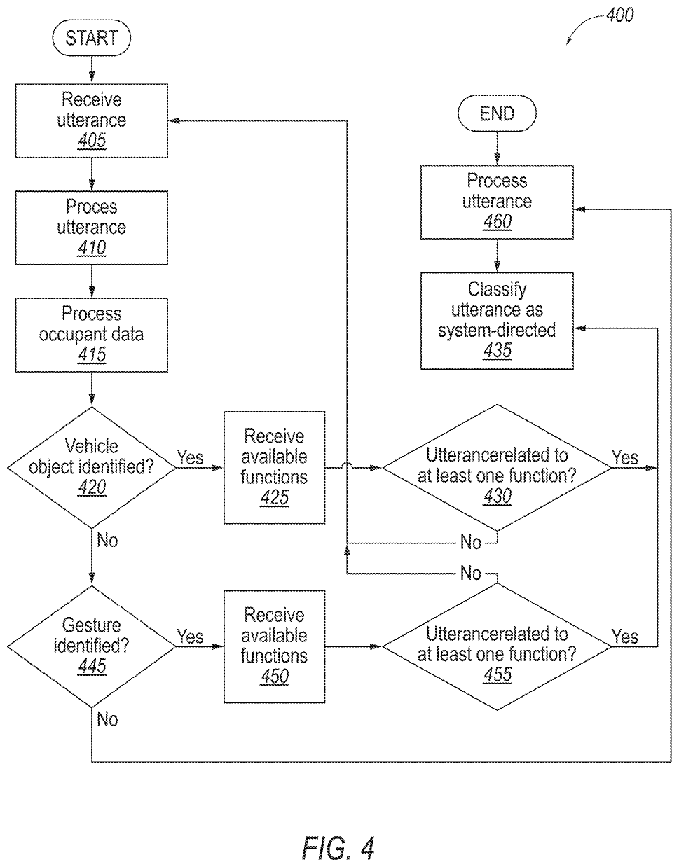

FIG. 4 illustrates an example flow chart for a process 400 for the automotive voice assistant system 100 of FIG. 1. The process 400 may begin at block 405, where the processor 106 receives an utterance from the microphone 132. The utterance may include human voice sounds that are either system-directed and intended to provide a command or request to the multimodal processing system 130, or a non-system-directed utterance that is typical human to human conversation.

At block 410, the processor 106 may process the utterance to determine the content of the utterance, e.g., the command or phrase spoken by the occupant. The processing may also determine other characteristics of the utterance, such as the tone, direction, occupant position within the vehicle, the specific occupant based on voice recognition, etc. Signal processing techniques including filtering, noise cancelation, amplification, beamforming, to name a few, may be implemented to process the utterance. In some instances, the tone of the utterance alone may be used to classify the utterance as system-directed or non-system-directed.

At block 415, the processor 106 may receive occupant data from the camera 152. The occupant data may be acquired at, or nearly at, the same point in time that the utterance was spoken. The occupant data, as explained, may include data visually depicted or acquired by the camera 152 and indicative of a gaze direction, gesture, or head position, of a specific occupant.

At block 420, the processor 106 may determine whether the occupant data is indicative of occupant attention directed to a recognized vehicle object or vehicle feature. For example, does the occupant data indicate that the occupant is gazing or looking at a certain vehicle object such as a knob, display, window, etc. The processor 106 may achieve this by detecting the occupant's gaze or head position and determining spatially within the vehicle cabin where the occupant is focusing his or her eyes. If the processor 106 determines that the occupant is looking at the center of the dashboard, the processor 106 may then determine that it is likely that the user is looking at the center display. The processor 106 may then use the object database 154 to look up if the object (e.g., the display 160,) is a recognized object. If so, the process 400 proceeds to block 425. If the object is not in the object database 156, the process 400 proceeds to block 445.

At block 425, in response to the object being a recognized object, the processor 106 may look up, based on the object database 156, available functions for the recognized object. For example, if the object is the windshield wiper control shaft, then the available functions and features may be related to the windshield wipers, such as turn on, turn off, increase or decrease speed, spray, etc.

At block 430, the processor 106 may determine whether the spoken utterance is related to the available functions for the recognized object. In continuing with the above example of the occupant's attention being directed to the windshield wiper controls, the processor 106 may determine whether the utterance make any mention of “rain” or “wipers.” If so, then the process 400 proceed to block 435. If not, then the processor 106 may determine that the utterance is not system-directed and proceed back to block 405 to listen for the next utterance.

At block 435, in response to the spoken utterance being associated with an available function or feature, the processor 106 may classify the utterance as system-directed.

At block 460, the processor 106 may process the utterance to determine whether the utterance includes a command and respond to the command.

At block 445, the processor 106 may determine whether the occupant data indicates a recognized gesture, such as a waiving of the hand, or shaking of the head, for example. If so, the process proceeds to block 450. If not, the process 400 proceeds to block 460.

At block 450, the processor 106 determines, based on the gesture database 158, the available functions associated with the gestures. For example, an arm wave in front of the display may indicate a desire to adjust one of the available options on the display, such as to increase or decrease the heat, volume, skip a song, change the radio station, etc.

At block 455, the processor 106 may determine whether the spoken utterance is related to the available functions or features for the recognized gesture. In taking the example above where the occupant waves his or her hand in front of a display, the processor 106 may determine that the utterance is related if the utterance mentions, “skip,” “music,” “it's too cold,” etc. If the utterance is related to the feature, the processor 106 may determine that the utterance is system-directed and proceed to block 430. If not, then the processor 106 may determine that the utterance is not system-directed and proceed back to block 405 to listen for the next utterance.

The process may then end.

Accordingly, described herein is a system configured to determine whether an utterance is system-directed or non-system-directed, among others, by analyzing the semantic content of the utterance. The system uses an auxiliary way of classifying whether the utterance is system-directed or non-system-directed based on the user's tone of voice. Additionally, the system may include a statistical classifier with a learning model based on example data whether users usually change their gaze and/or gestures when speaking a command vs. speaking non-system-directed utterances.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (erasable programmable read-only memory (EPROM) or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable.

The flowcharts and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A vehicle system for classifying spoken utterance within a vehicle cabin as one of system-directed and non-system directed, the system comprising:
at least one microphone configured to detect at least one acoustic utterance from at least one occupant of a vehicle;
at least one camera configured to detect occupant data indicative of occupant behavior within the vehicle corresponding to the acoustic utterance, wherein the occupant data includes gaze direction data indicative of an occupant gaze direction;
a memory configured to maintain a database of recognized occupant behaviors including at least one stored gaze direction, the stored gaze direction being directed to an object within the vehicle corresponding to a plurality of predefined vehicle features, the object imposing an effect on at least one vehicle system; and
a processor programmed to:
receive the acoustic utterance,
receive the occupant data,
in response to occupant gaze direction corresponding to the at least one stored gaze direction directed to the object within the memory, classify the acoustic utterance as a system-directed utterance in response to the occupant data being indicative of the occupant attention being directed to the object,
process the acoustic utterance in response to classifying the acoustic utterance as being a system-directed utterance and identify one of the plurality of predefined vehicle features to operate using the acoustic utterance and the occupant gaze direction.

2-3. (canceled)

4. The system of claim 1, wherein the memory maintains at least one vehicle feature associated with each occupant behavior, the at least one vehicle feature configured to respond to commands included in the at least one acoustic utterance.

5. (canceled)

6. The system of claim 1, wherein the processor is further programmed to determine whether the acoustic utterance is related to the vehicle feature.

7. The system of claim 6, wherein the processor is further programmed to classify the acoustic utterance as a system-directed utterance in response to the acoustic utterance being related to the vehicle feature.

8. The system of claim 1, wherein the occupant data is indicative of a gesture made by the occupant.

9. The system of claim 8, further comprising a memory configured to maintain a database of recognized gestures and at least one vehicle feature associated with each of the recognized gestures, the at least one vehicle feature configured to respond to commands included in the at least one acoustic utterance, and
wherein the processor is further programmed to determine whether the occupant data is indicative of the occupant attention being directed to the vehicle feature in response to the gesture being associated with one of the at least one vehicle feature within the database.

10. A method for classifying spoken utterance within a vehicle cabin as one of system-directed and non-system directed, the method comprising:
receiving an acoustic utterance from a vehicle occupant from at least one microphone;
receiving occupant data indicative of occupant behavior from at least one camera, wherein the occupant data includes an occupant gaze direction;
determining whether the occupant data is indicative of occupant attention directed to an object within the vehicle in response to the occupant gaze direction corresponding to the at least one gaze direction stored in memory onboard the vehicle, the object being corresponding to a plurality of predefined vehicle features selectively impose at least one effect on at least one vehicle system;
classifying the acoustic utterance as a system-directed utterance in response to the occupant data being indicative of the occupant attention to the object; and
determining one of the plurality of predefined vehicle features to operate by processing the acoustic utterance.

11-12. (canceled)

13. The method of claim 10, further comprising determining whether the occupant data is indicative of the occupant attention being directed to the vehicle feature in response to the occupant behavior being included in the database.

14-15. (canceled)

16. The method of claim 10, wherein the occupant data includes a gesture made by the occupant.

17. The method of claim 16, wherein further comprising determining whether the occupant data is indicative of the vehicle feature in response to the gesture being associated with the vehicle feature.

18. An audio system for classifying spoken utterance as one of system-directed and non-system directed, the system comprising:
at least one microphone configured to detect at least one acoustic utterance from at least one user;
at least one camera configured to detect data indicative of user behavior including of an occupant gaze direction associated with the acoustic utterance;
a memory configured to maintain a database of user behaviors indicative of occupant attention being directed to at least one stored gaze direction, the gaze direction being directed to an object within the vehicle corresponding to a plurality of predefined features; and
a processor programmed to
receive a first acoustic utterance,
receive a first data indicative of the user behavior corresponding to the first acoustic utterance,
determine that the first data is indicative of occupant attention directed to the object in response to the occupant gaze direction of the first data corresponding to the at least one stored gaze direction,
determine whether the user behavior is associated with the first acoustic utterance,
classify the first acoustic utterance as a system-directed utterance in response to the first data indicative of the user behavior being associated with the first acoustic utterance,
process the first acoustic utterance to determine one of the plurality of predefined features to operate, and
operate the one of the plurality of predefined features using the acoustic utterance.

19. (canceled)

20. The system of claim 18, wherein the user behavior further includes a gesture.

21. The system of claim 18, wherein the processor is further programmed to:
receive a second acoustic utterance,
receive a second data indicative of the user behavior corresponding to the second acoustic utterance,
determine that the second data is indicative of occupant attention not directed to a vehicle feature in response to the occupant gaze direction of the second data corresponding to the at least one stored gaze direction,
analyze the second utterance,
classify the second acoustic utterance as non-system-directed based on the second data including the gaze direction and the analyzing of the second utterance.
